(19) United States
(12) Patent Application Publication
(10) Pub. No.: US 2007/0228092 A1
(43) Pub. Date: Oct. 4, 2007

(54) Aid for persons with disabilities

(76) Inventor: Michael Hammermeister, Eisingen (DE)

Correspondence Address: RABIN & Berdo, PC, 1101 14TH STREET, NW, SUITE 500, WASHINGTON, DC, 20005, US

(21) Appl. No.: 11/295,693

(22) Filed: Dec. 7, 2005

(30) Foreign Application Priority Data
Dec. 8, 2004 (DE) 20 2004 018 962.3

(51) Int. Cl. B43L 15/00; B25B 33/00

(52) U.S. Cl. 224/218; 294/25

(57) ABSTRACT

A device for aiding disabled persons, of the type of a writing aid or a typing aid, is provided with a saddle that can be fitted onto a hand. A holding device for a writing tool or an extension is arranged on the saddle.

The invention relates to a device for aiding persons with disabilities, of the type of a writing aid as defined in claim 1, as well as a typing aid as defined in claim 5.

Persons who are no longer able to hold a pen because of paralysis in the fingers or in the hand are no longer able to write. Frequently, it would be helpful if these persons could at least sign their names or could communicate with a few written words. Paraplegics or stroke patients, in particular, can control the image of writing and text with their minds.

Devices used so far for patients with these disabilities have considerable deficiencies, wherein this concerns attaching the device to the hand and the mechanical holding ability. Above all, it is important that a writing aid can be attached securely to the hand, so that a writing tool can be guided in the way the brain instructs the hand.

Patients with paralysis of this type have to depend on these aids when they are at work. It is therefore important that they can depend fully on such aids. Writing aids are important devices in particular when relearning writing following a paralysis, or when participating in a drawing/painting therapy.

The same is true for the typing aid used by people with paralysis in their fingers or hands, which allows them to use the keys of a computer keyboard. Here too, a secure guidance of the typing aid and a robust design are a precondition for the reliable use of such an aid.

It is therefore the object of the present invention to make available a new type of device for aiding persons with disabilities, which meets the special requirements of the disabled.

According to a first aspect of the invention, this object is solved with the subject matter of claim 1. A writing aid of this type has the advantage of fitting securely on the hand, so that the writing tool actually follows the movements dictated by the brain. As a result, it easier to relearn the skill of writing following paralysis and the writing of a disabled person becomes clearer and more legible. The writing tool is held securely in place with this, thereby avoiding an undesirable change in the position of the writing tool during the writing operation.

According to a second aspect of the invention, this object is solved with the subject matter of claim 5. A typing aid of this type allows a person with hand-paralysis or finger-paralysis to use the keyboard of a computer, for example, or to operate a telephone system. By also using the thumb, the aid is secured extremely well on the hand, thus reducing writing errors.

Further details and advantageous embodiments of the invention follow from the exemplary embodiments, described in the following and shown in the drawing, which should not be understood as restricting the invention. Shown are in:

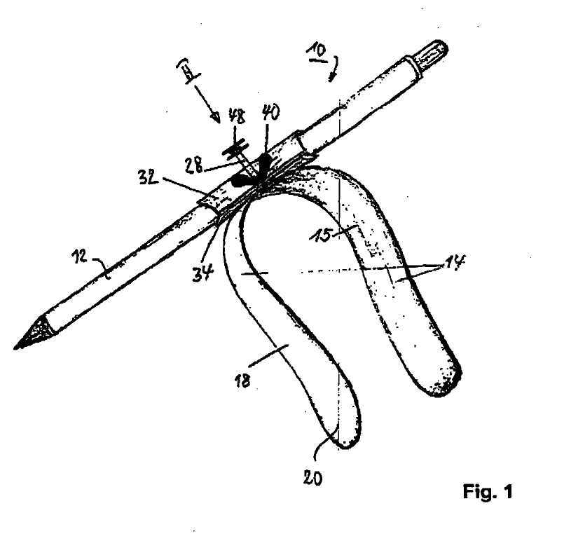

FIG. 1: A three-dimensional image of a device for aiding disabled persons, in the form of a writing aid according to the invention;

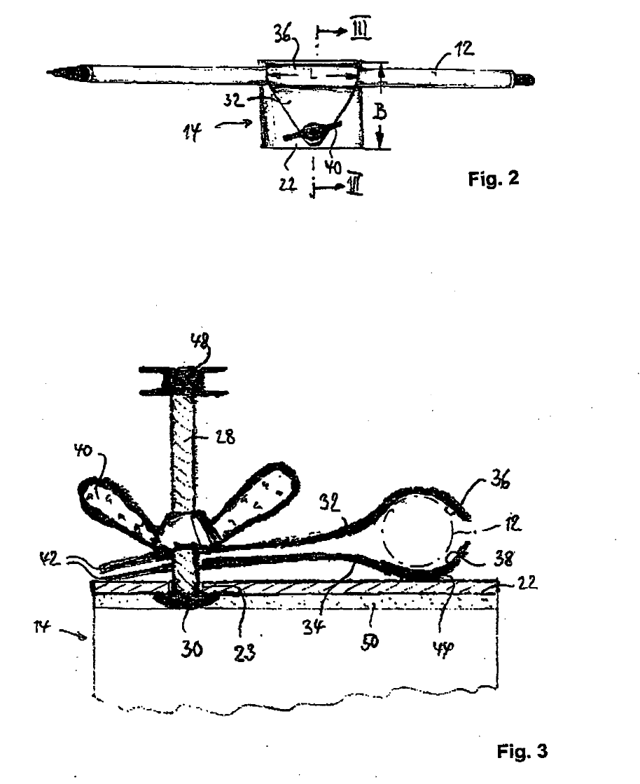

FIG. 2: A view from above of the writing aid, as seen in the direction of arrow II, which

FIG. 3: Shows a section seen in the direction of line III-III in FIG. 2;

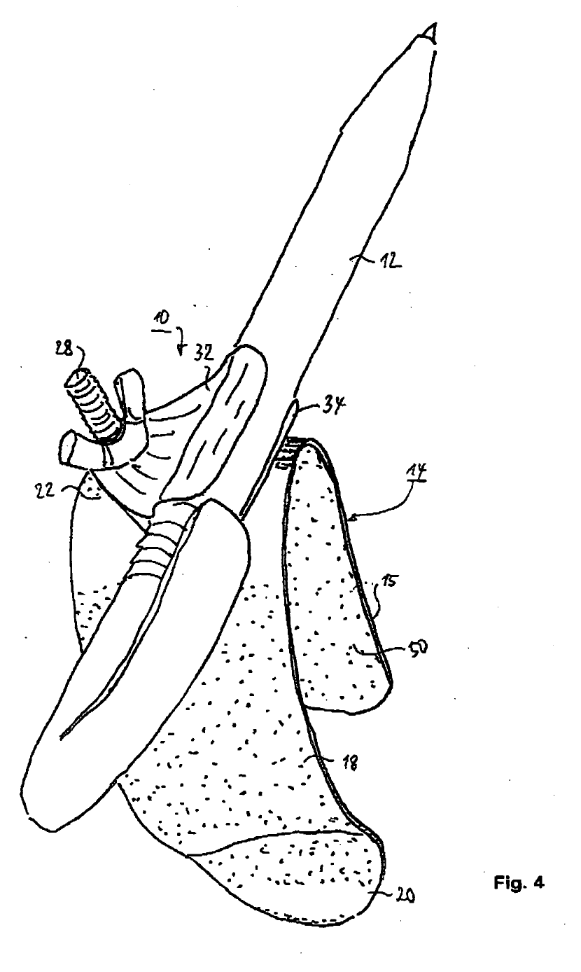

FIG. 4: A three-dimensional representation, showing particularly clearly the fastening of a writing tool;

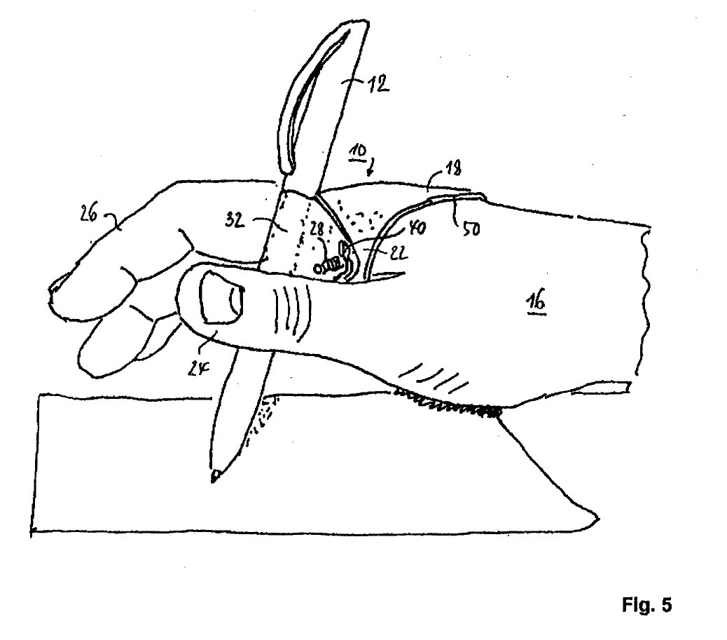

FIG. 5: A three-dimensional representation showing the writing of a person with finger or hand paralysis;

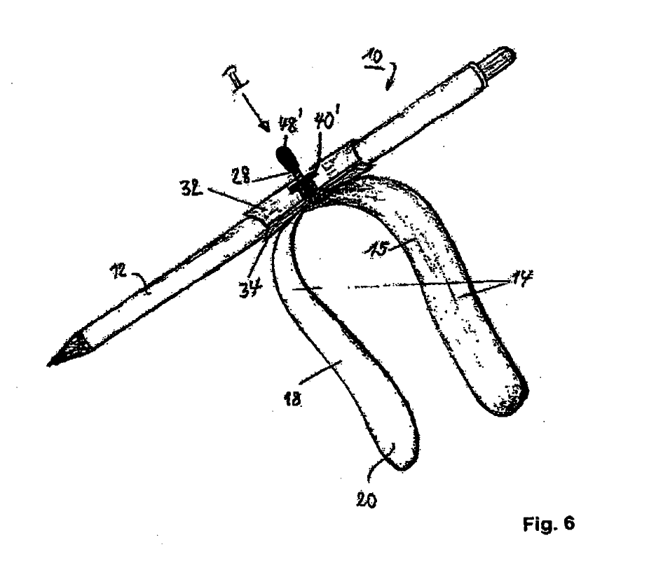

FIGS. 6-12: An alternative embodiment of the writing aid which is shown in FIGS. 1 to 5;

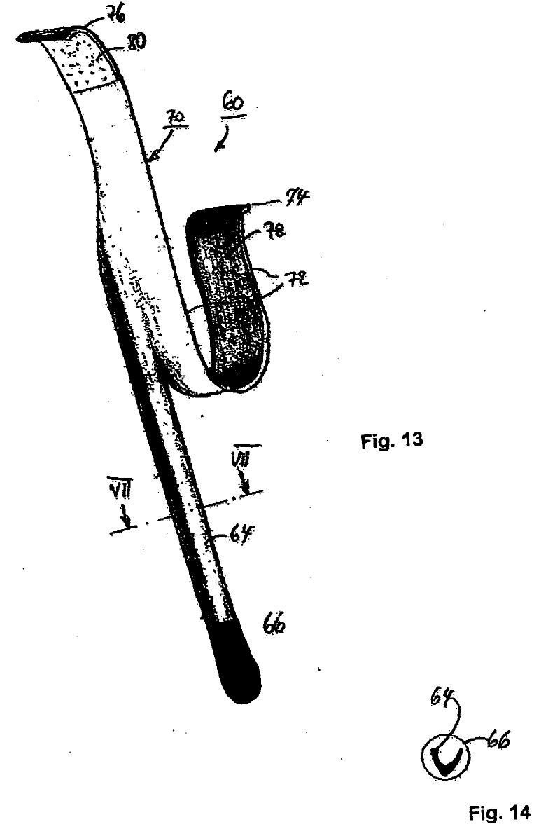

FIG. 13: A device for aiding the disabled, in the form of a typing aid according to the invention, shown in a three-dimensional view;

FIG. 14: A section as seen along the line VII-VII in FIG. 13;

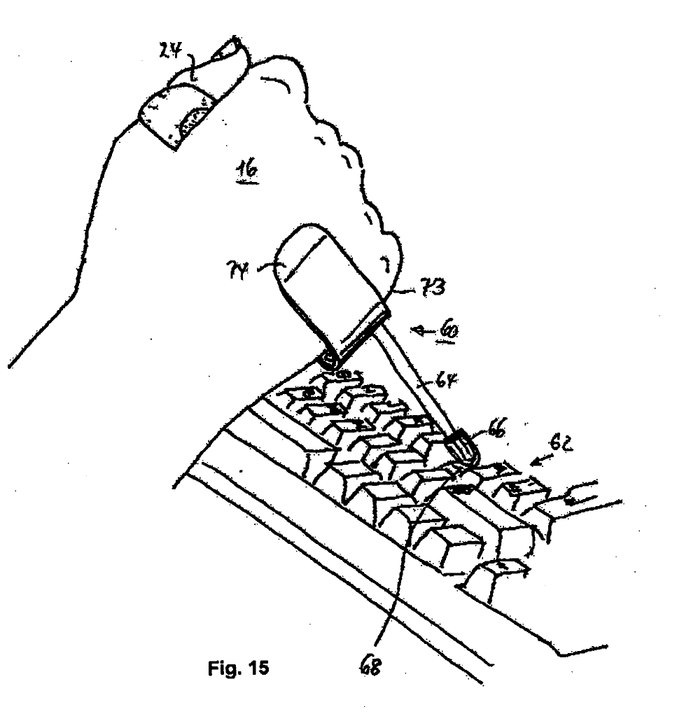

FIG. 15: A three-dimensional view showing the use of a small typing hammer according to the invention; and

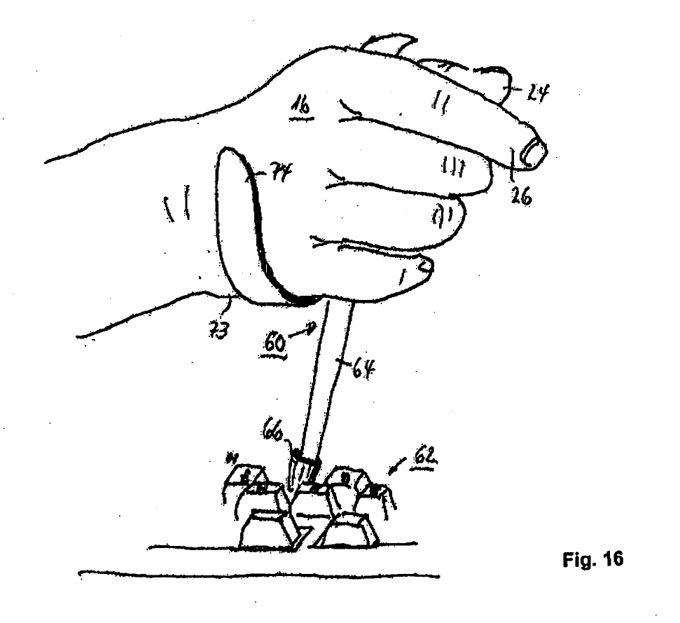

FIG. 16: A three-dimensional view analog to FIG. 15, but seen from a different viewing angle.

FIG. 1 shows a writing aid 10 to which a mechanical pencil 12 (FIGS. 1 to 3) or a ballpoint pen (FIG. 4) is attached as illustration. This writing aid 10 has a saddle 14 of a ductile metal, preferably brass. As a result of the ductile characteristics of the metal, the saddle can be bent individually and ergonomically to fit the hand, wherein the spring tensioning force of the saddle is distributed across the surface. This saddle 14 has an inside cheek 15 which fits during use against the inside surface of the hand 16 of the disabled person. The saddle also has an outside cheek 18, which fits during use against the back of this hand 16, as shown in FIG. 5. This results in two opposite-arranged thrust bearings, wherein one thrust bearing fits against the back of the hand and the other thrust bearing fits against the inside surface of the hand, thus ensuring a counter bearing. The exposed end 20 of the outside cheek 18 is bent somewhat away from the hand 16, best shown in FIG. 4, thereby making it possible for the disabled person to push the writing aid 10 away with the other hand and, so-to-speak, “pull it off.”

A so-called saddle block 22 is positioned at the area of transition from the inside cheek 15 to the outside cheek 18 of saddle 14. As shown in FIG. 5, this saddle block is inserted between thumb 24 and index finger 26 of the writing hand 16, wherein the thumb 22 is bent away. At the proximal end of this saddle block 22, a flathead screw 28 is screwed into an internal thread 23, such that its flat head 30 points toward the hand 16, meaning in proximal direction.

The screw 22 is used to fasten two claw-like [bracket-type?] holders 32, 34 which are provided at the exposed ends, meaning on the right side in FIG. 3, with respectively one shaped cavity 36 and/or 38, between which the writing tool 12 is clamped in during use, as shown with dash-dot lines in FIG. 3.

A wing nut 40, which is screwed onto the screw 28, is preferably used for clamping in the holding claws 32, 34; compare FIG. 3.

For this, the nut 40 presses the holding claws 32, 34 with the left ends 42, shown in FIG. 3, against the proximal side of the saddle block 22 and it presses the lower holding claw 34 with its outside 44 from the rounded area toward the distal side of the saddle block 22; compare also FIG. 3. In the process, the holding claws 32, 34 are elastically pre-stressed. For that reason, the lower holding claw 34 fits with elastic pre-stressing in two locations against the saddle block 22. Given sufficient pre-stressing, this securely prevents a turning of the writing tool 12 relative to the saddle 14. This fact is critical because a helper is frequently needed to adjust the position of the writing tool 12 on the saddle 14. The disabled person wants then wants to be sure that the position of the writing tool, once it is adjusted, will not change again. This is aided by the fact that the length L (FIG. 2) of the rounded sections 36, 38 approximately corresponds to the width B of the saddle 14, which ensures a good clamping in and guidance of the writing tool 12. Furthermore, the force introduced by the writing tool is distributed to the two support locations for the lower holding claw 34. The saddle is thus prevented from tilting and the force is distributed evenly over the complete width of the saddle 14.

With the aid of FIGS. 4 and 5, it can be seen that the holding claws 32, 34 are oriented such that the writing tool 12 held by these claws is located on the side facing away from the thumb (distal side) of saddle block 22. This is important for achieving a good control of the movement of the writing tool with simultaneously solid and comfortable hold of the writing aid.

According to FIG. 3, a gripping part (handle) 48 of plastic is attached to the exposed end of screw 28. A disabled person can grip this part with the cutting teeth in order to easily pull the writing aid off the hand 16.

FIG. 5 shows the hand 16 to which the writing aid 10 is attached by fitting it on. A support layer 50 of sponge rubber or the like is located on the inside of the saddle 14. The writing tool 12 is positioned between the thumb 24 and the index finger 26 and is used in this case for writing on a sheet of paper 50. Since the saddle 14 fits with an adjustable pre-tensioning against the hand 16, a good seat is ensured and the hand movements are transferred precisely to the writing tool 12. The disabled person can thus write clearer and more legibly and any painting/drawing therapy is made easier.

If the writing aid 10 was bent as a result of being dropped, it can be returned easily to its old shape. The necessary spring force can be adjusted easily with such a writing aid. The sponge rubber layer 50 increases the adherence to the hand and provides a warm and easy fit.

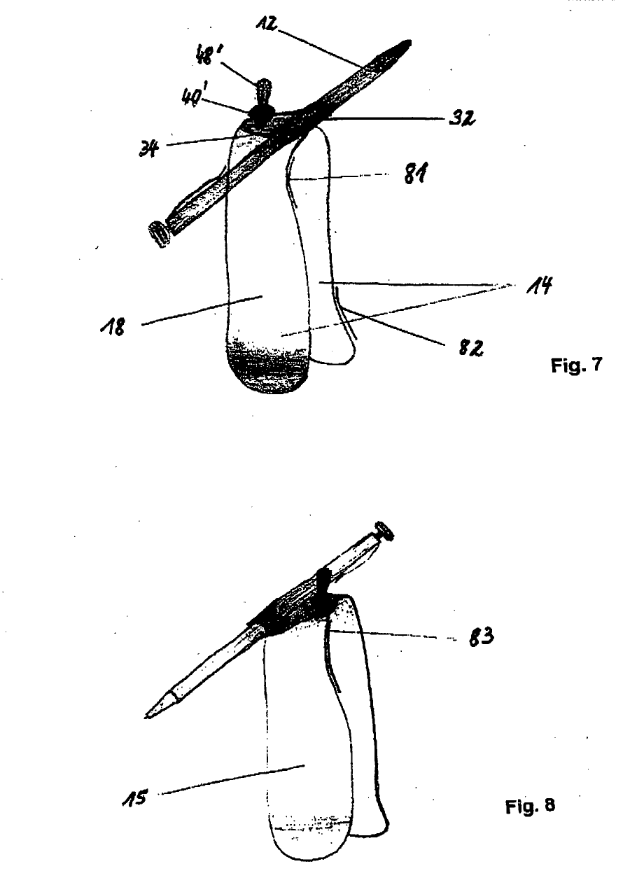

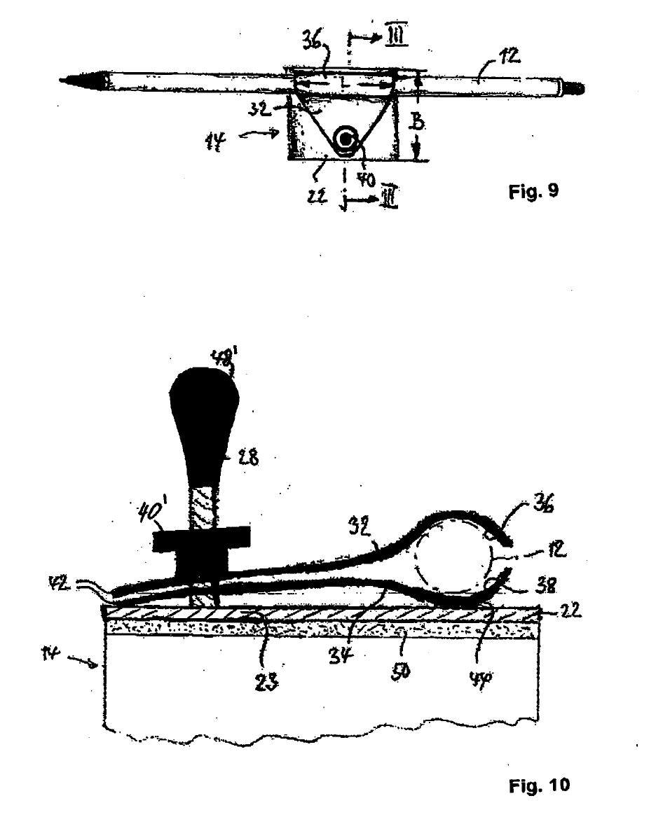

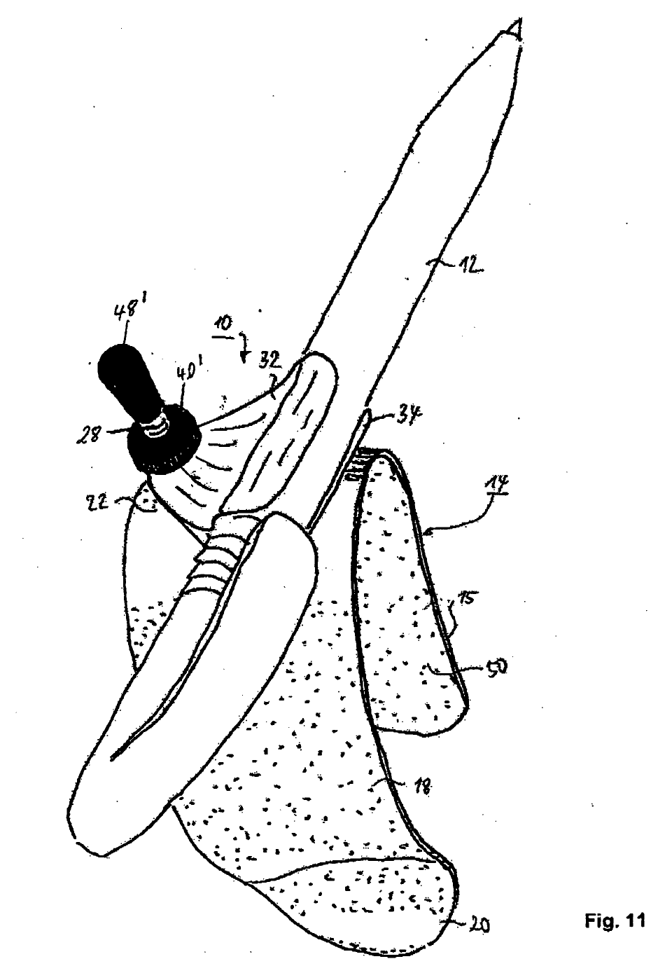

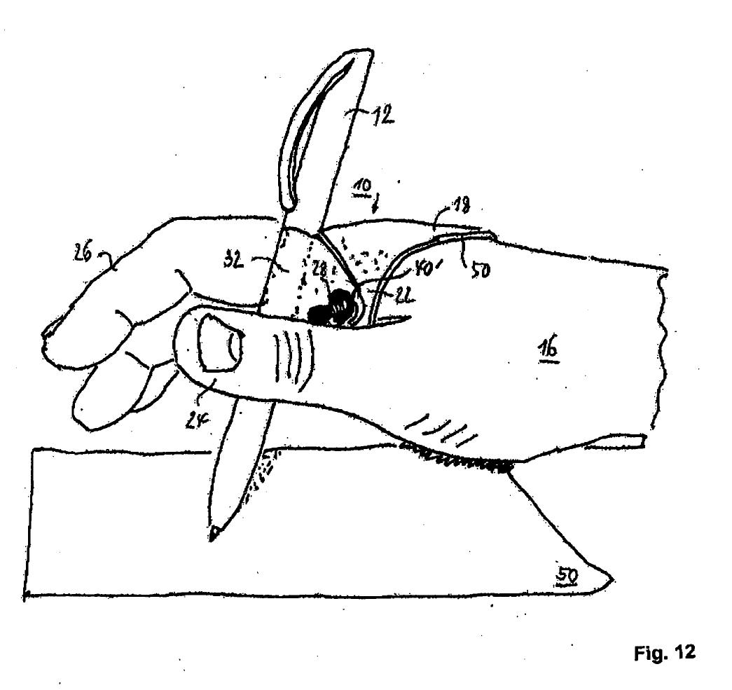

FIGS. 6 to 12 show one alternative and, as a rule, preferred embodiment of the above-described writing aid. The FIG. 6 in this case corresponds to FIG. 1, the FIG. 9 corresponds to FIG. 2, the FIG. 10 corresponds to FIG. 3, the FIG. 11 corresponds to FIG. 4, and the FIG. 12 corresponds to FIG. 5. The perspective representations of FIGS. 7 and 8 have no corresponding counterparts in the representation of the first embodiment. The basic design is the same as for the first embodiment, so that in the following we will discuss only the differences to the first embodiment:

Above all, the saddle and preferably also the holding claws are made from stainless steel [high-grade steel?] since the ductile characteristics of this material match the geometric form of the writing aid even more, thus making it possible to obtain a secure hold, good adaptability, and high wearing comfort.

The wing nut is replaced with a round stainless steel nut 40′, to which a gripping part 48′ of rubber is attached. This embodiment makes it easier to “pull off” the writing aid by using the teeth. Also, for reasons of increased comfort and being gentle to the skin, the inside of the saddle is lined with leather 50′.

As previously explained, the outside cheek 18 rests on the back of the hand. To ensure that the knuckles remain free, the outside cheek is provided with a recessed area 81 (see FIG. 7) on the side facing the fingers. On the one hand, this ensures that the knuckles which are generally very sensitive remain unstressed while, on the other hand, it further supports the outside cheek 18 fitting flat against the back of the hand because there is no danger that the outside cheek 18 will hit the knuckles and is thus pushed off the back of the hand.

The inside cheek 15 rests ergonomically on the hand surface. To support this, the inside cheek 15—as shown in FIG. 8—is provided with an additional recessed area 83 which extends around the thumb root ball and thus rests better to the inside surface of the hand.

FIGS. 13 to 16 illustrate a typing aid 60 that is primarily used with a keyboard 62, as shown with exemplary embodiments in FIGS. 8 and 9.

The typing aid 60 according to FIG. 13 has a stem 64, with a rubber part 66 attached to the exposed end, which protects the keyboard 62. FIGS. 15 and 16 show how a key 68 is depressed with this rubber part 66.

The stem 64 is formed in that a sheet-metal part is bent approximately at a right angle, as shown in FIG. 14. This sheet-metal part together with a sheet-metal part 70 for the saddle forms a single piece with an approximate cross-sectional shape of an F-hole (sound hole) of a violin.

Its lower part shown in FIG. 13 is shaped like a saddle 72 which is fitted over the edge of a hand 74 during use, as illustrated in FIGS. 15 and 16, wherein the exposed end 74 of the saddle 72 fits onto the back of the hand and, in the end region, projects somewhat away from it to allow the disabled person to slide off the typing hammer 60 with the aid of the other hand.

According to FIG. 6, the other portion of the saddle 72 preferably forms one piece together with the pin 64. In the upper section of FIG. 6, it transitions into a bent part 76 which fits against the back of the thumb 24, as shown in FIG. 15, thus resulting in an extremely stable position relative to the hand 16.

Here too, the respective concave side of the sheet metal 72 for the saddle and the upper, bent portion 76 is provided with a sponge rubber support layer 78 and/or 80 in order to cushion the support surface and to permit a long-term use without difficulties.

The part 70 in this case is also preferably made of sheet brass or stainless steel to ensure the required mechanical strength, a certain resiliency, and a weight that is desirable for the use. The somewhat higher inherent weight as compared to plastic parts has a positive effect because the disabled person is not required to push down on the paper and can therefore concentrate on the writing movements.

The extremely high life expectancy of the aid according to the invention is also very positive. Its shape can be adapted individually to a plaster cast of the hand of the disabled person, so that an optimal fit is obtained, which permits a non-tiring operation. A breaking of the aid during the fitting on or pulling off is avoided with the invention and there are no permanent damages, even if it is dropped occasionally, as cannot be avoided for disabled persons.

1. A device for aiding a disabled person, in the form of a writing aid,
comprising a saddle-shaped part designed to complement a hand, the saddle-shaped part being provided in a region of largest curvature of the hand with a saddle block that is positioned between a thumb and an index finger during use,
further comprising a plurality of opposing claw-like holding parts, which are provided in each end region with a section having an essentially semi-circular cross section,
which sections jointly form a guide for a writing tool,
and which are connected in the other end region by means of a screw connection to the saddle block, wherein the holding part that is closer to the saddle block fits in a region of the screw connection as well as in a region of the rounded area and is pre-tensioned against the saddle block when holding the writing tool.

2. A device for aiding disabled persons as defined in claim 1, wherein the screw connection is designed such that it can be removed for replacing the writing tool.

3. A device for aiding disabled persons as defined in claim 1, with a gripping part provided on the screw connection, such that the gripping part can be gripped by teeth of the disabled person in order to pull the writing aid from the hand.

4. A device for aiding disabled persons as defined in claim 1, wherein during use the saddle-type part is bent away in the end region (20) that fits against the back of the hand, so that the device can be pulled off one hand by using the back of the other hand.

5. A device for aiding disabled persons of the type of a typing aid,
comprising a part designed to be complementary to the hand, which encircles the edge of the hand in the manner of a saddle with a U-shaped part, as seen in the cross section,
wherein one leg of the U comes to rest against the back of the hand,
and an extension is provided on the other leg, on the side of the back of the hand, which points away from the hand, wherein this extension is provided on its exposed end with a part of an elastomer material, designed for typing on a keyboard or the like,
and wherein this other leg is provided with a section that is designed to fit during use against one side of the thumb of this hand and is provided with a curvature for fitting against this side of the thumb.

6. The device for aiding disabled persons as defined in claim 5, wherein the U leg facing the back of the hand is provided with an end region that is bent somewhat away from the back of the hand during use, so as to make it easier for the disabled person to pull the device off by using the other hand.

7. The device for aiding disabled persons as defined in claim 5, wherein the parts that are designed complementary to the hand are made of metal, in particular stainless steel, and are embodied so as to be cushioned on the side facing the hand.

8. The device for aiding disabled persons as defined in claim 7, wherein the cushioning is formed with a layer of leather or the like.
